(19) United States
(12) Patent Application Publication
(10) Pub. No.: US 2015/0026013 A1
(43) Pub. Date: Jan. 22, 2015

(54) SYSTEM AND METHODS FOR COGNITIVE VISUAL PRODUCT SEARCH

(71) Applicant: Cldi Inc., Daejeon (KR)

(72) Inventors: Seung-Wook PAEK, Daejeon (KR); Jung-In LEE, Seoul (KR); Dong-Geun YOO, Daejeon (KR); Kyung-Hyun PAENG, Busan (KR); Sung-Gyun PARK, Icheon (KR); Min-Hong JANG, Iksan (KR)

(21) Appl. No.: 14/333,925

(22) Filed: Jul. 17, 2014

Related U.S. Application Data
(60) Provisional application No. 61/856,805, filed on Jul. 22, 2013.

(30) Foreign Application Priority Data
Dec. 9, 2013 (KR) 2013-0152089

(51) Int. Cl. G06Q 30/06; G06F 17/30

(52) U.S. Cl. CPC G06Q 30/0625; G06Q 30/0643; G06F 17/30247
USPC 705/26.62

(57) ABSTRACT

A visual product searching apparatus includes a product area determining part, a visual word generating part and a product searching part. The product area determining part extracts a product area in an input image. The visual word generating part generates a visual word reflecting human visual cognitive characteristics based on the product area. The product searching part searches a product using the visual word.

### PRIORITY STATEMENT

This application claims priority under 35 U.S.C. §119 to U.S. Provisional Application No. 61/856,805 filed on Jul. 22, 2013 in the USPTO, and Korean Patent Application No. 10-2013-0152089, filed on Dec. 9, 2013 in the Korean Intellectual Property Office (KIPO), the contests of which are herein incorporated by reference in their entireties.

### BACKGROUND

1. Technical Field

Exemplary embodiments relate to a visual product searching apparatus and a method of visually searching a product using the visual product searching apparatus. More particularly, exemplary embodiments relate to an automated visual product searching apparatus and a method of visually searching a product using the visual product searching apparatus.

2. Description of the Related Art

There are various products on websites as online purchasing is widely used. To effectively search a desired item among the various products, visual information such as a color and a pattern has to be searched.

Conventional visual product searching systems rely on a tagging which is performed manually. In the conventional visual product searching systems, it is not efficient to handle various items in a database. In addition, tagging all the items is practically impossible as the number of products on websites increases.

### SUMMARY

Exemplary embodiments provide a visual product searching apparatus automatically extracting and classifying visual information of a product

Exemplary embodiments also provide a method of visually searching a product using the visual product searching apparatus.

In an exemplary visual product searching apparatus according to the present inventive concept, the visual product searching apparatus includes a product area determining part configured to extract a product area in an input image, a visual word generating part configured to generate a visual word reflecting human visual cognitive characteristics based on the product area and a product searching part configured to search a product using the visual word.

In an exemplary embodiment the product area determining part may include a contour detecting part configured to detect a contour of an object in the input image and a product area extracting part configured to determine whether the product area is detected or not based on the contour of the object and a product category.

In an exemplary embodiment, when the product area is detected, the product area extracting part may extract an image in the product area to generate an output image. When the product area is not detected, the product area extracting part may generate the output image using the input image.

In an exemplary embodiment, the product area extracting part may operate training for determining a boundary between a success and a failure to detect the product area using a plurality of sample images for respective product categories.

In an exemplary embodiment, the product area extracting part may generate a virtual box having a rectangular shape which is defined by horizontal outermost points of the contour of the object and vertical outermost points of the contour of the object and may determine whether the product area of the input image is detected or not using a histogram including distances from a central point of the virtual box to the contour of the object in various directions.

In an exemplary embodiment, the visual word generating part may operate numerical clustering to visual information and may operate cognitive clustering to the numerical clusters reflecting human visual cognition characteristics. The visual word generating part may generate the visual word of the output image outputted from the product area determining part based on the cognitive clusters.

In an exemplary embodiment, the visual word may represent a color. The colors may be numerically clustered using a distance of color coordinates defined by a plurality of axes. The cognitive clustering may use a second color space. The first color space may be nonlinearly converted to generate the second color space. The second color space may have a dimension higher than a dimension of the first color space.

In an exemplary embodiment, the product searching part may receive a searching query and may output a searching result corresponding to the searching query. The searching query may include a plurality of colors of the product having different ratios from one another.

In an exemplary embodiment, the product searching past may include a visual database configured to store the visual word of the product and a non-visual database configured to store non-visual information of the product. The visual database and the non-visual database may be linked with each other by a product key.

In an exemplary method of visually searching a product according to the present inventive concept, the method include extracting a product area in an input image, generating a visual word reflecting human visual cognitive characteristics based on the product area and searching the product using the visual word.

In an exemplary embodiment, the extracting the product area may include detecting a contour of an object in the input image and determining whether the product area is detected or not based on the contour of the object and a product category.

In an exemplary embodiment, the determining whether the product area is detected or not may include when the product area is detected, extracting an image in the product area to generate an output image and when the product area is not detected, generating the output image using the input image.

In an exemplary embodiment, the generating the visual word reflecting human visual cognitive characteristics may include operating numerical clustering to visual information, operating cognitive clustering to the numerical clusters reflecting human visual cognition characteristics and generating the visual word of the output image outputted from the product area determining part based on the cognitive clusters.

According to the visual product searching apparatus and the method of visually searching the product, the visual information of the products is automatically extracted and classified so that the visual information of the products may be effectively searched.

In addition, the product area is extracted in the product image so that the visual information may be accurately searched.

In addition, when the visual word is determined from the extracted product area, a cognitive clustering is performed based on the human visual characteristics so that a satisfaction of the searching result of the visual information may be improved.

### BRIEF DESCRIPTION Of THE DRAWINGS

The above and other features and advantages of the present inventive concept will become more apparent by describing in detailed exemplary embodiments thereof with reference to the accompanying drawings, in which:

FIG. 1 is a block diagram illustrating a visual product searching apparatus according to an exemplary embodiment of the present inventive concept;

FIG. 2 is a flowchart illustrating a method of visually searching a product using the visual product searching apparatus of FIG. 1;

FIG. 3 is a block diagram illustrating a product area determining part of FIG. 1;

FIG. 4 is a conceptual diagram illustrating an operation of the product area determining part of FIG. 1;

FIG. 5 is a flowchart diagram illustrating an operation of a visual word generating part of FIG. 1; and

FIG. 6 is a conceptual diagram illustrating a structure and an operation of the visual product searching apparatus of FIG. 1.

### DETAILED DESCRIPTION OF THE EMBODIMENTS

The present inventive concept now will be described more fully hereinafter with reference to the accompanying drawings, in which exemplary embodiments of the present invention are shown. The present inventive concept may, however, be embodied in many different forms and should not be construed as limited to the exemplary embodiments set fourth herein.

Rather, these exemplary embodiments are provided so that this disclosure will be thorough and complete, and will fully convey the scope of the present invention to those skilled in the art. Like reference numerals refer to like elements throughout.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular exemplary embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the inventive concept as used herein.

Hereinafter, the present inventive concept will be explained in detail with reference to the accompanying drawings.

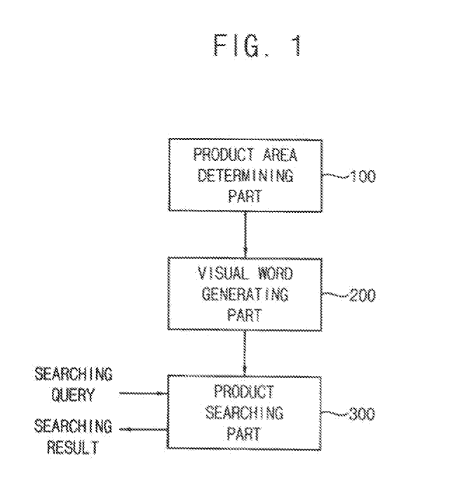

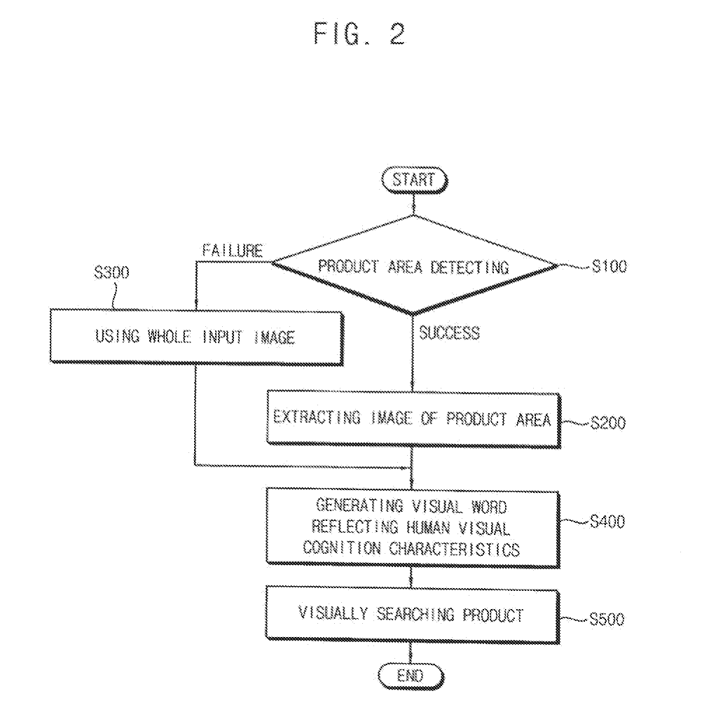

FIG. 1 is a block diagram illustrating a visual product searching apparatus according to an exemplary embodiment of the present inventive concept. FIG. 2 is a flowchart illustrating a method of visually searching a product using the visual product searching apparatus of FIG. 1.

Referring to FIGS. 1 and 2, the visual product searching apparatus includes a product area determining part 100, a visual word generating part 200 and a product searching part 300.

The product area determining part 100 determines an area of a product in an input image (step S100). The product area determining part 100 receives the input image and a product category. The product area determining part 100 determines whether the input image corresponds to the product category.

When the product area is detected based on the input image and the product category, the product area determining part 100 extracts an image portion in the product area to generate an output image (step S200).

When the product area is not detected based on the input image and the product category, the product area determining part 100 generates the output image using the whole input image (step S300). The product area determining part 100 outputs the whole input image as the output image.

In an exemplary embodiment, when the product area is not detected based on the input image and the product category, a result of detecting the product area, which represents a false, may be recorded. Therefore, the output image in case that the product area is not detected may have a low priority in a practical searching step.

In an exemplary embodiment, when the product area is not detected based on the input image and the product category, the output image may not be generated. Therefore, the input image in case that the product area is not detected may not affect a searching result in the practical searching step.

For example, when the product area determining part 100 receives an input image including a red t-shirt having a clear contour on a white background and the product category is a t-shirt, the product area determining part 100 may succeed to detect the product area. The product area determining part 100 removes the white background and extracts the image in the contour of the red t-shirt to generate the output image.

For example, when the product area determining part 100 receives an input image including a red t-shirt having an unclear shape on a white background and the product category is a t-shirt, the product area determining part 100 may fail to detect the product area. The product area determining part 100 generates the output image using the whole input image including both the unclear shape of red t-shirt and the white background.

For example, when the product area determining part 100 receives an input image including a red t-shirt having a clear contour on a white background and the product category is a hat, the product area determining part 100 may fail to detect the product area. The product area determining part 100 generates the output image using the whole input image including both the shape of the red t-shirt and the white background.

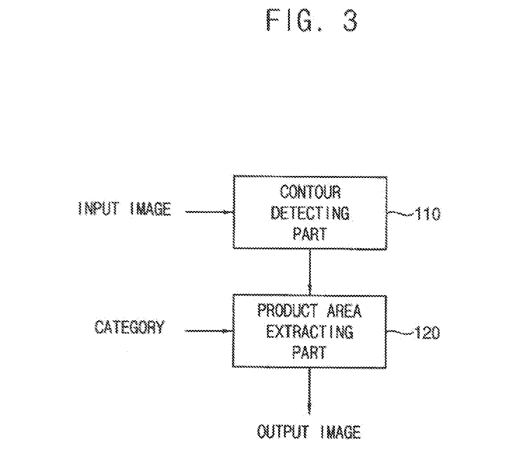

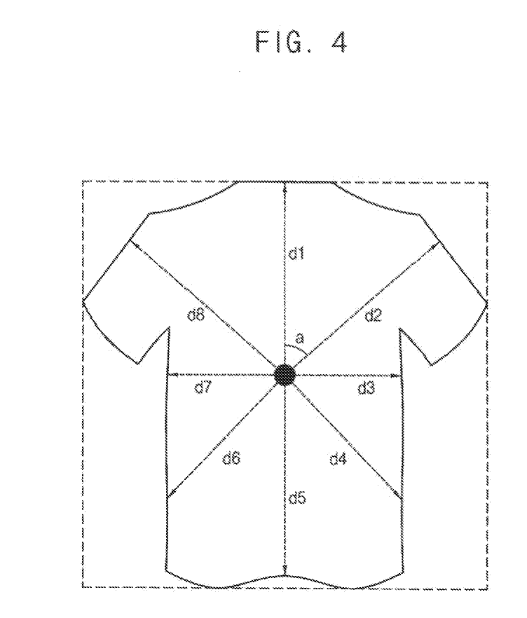

A structure and an operation of the product area determining part 100 are explained referring to FIGS. 3 and 4 in detail.

The visual word generating part 200 generates a visual word based on the product area (step S400). The visual word generating part 200 generates the visual word reflecting human visual cognition characteristics. The visual word generating part 200 may generate the visual word reflecting human visual cognition characteristics with respect to the output image of the product area determining part 100.

For example, when the product area determining part 100 succeeds to detect the product area, the visual word generating part 200 generates the visual word tor the image in the product area. When the product area determining part 100 fails to detect the product area, the visual word generating part 200 generates the visual word for the whole input image.

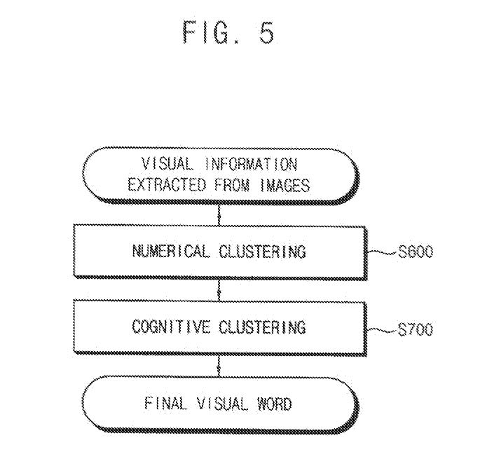

A structure and an operation of the visual word generating part 200 are explained referring to FIG. 5 in detail.

The product searching part 300 searches a product using the visual word generated from the visual word generating part 200 (step S500). For example, the visual word may include a color of the product. In addition, the visual word may include a pattern of the product. The product searching part 300 receives a searching query and outputs a searching result corresponding to the searching query.

The searching query may include a visual searching query. The searching query may include a non-visual searching query.

For example, the visual searching query includes a color of the product. The visual searching query may include a plurality of colors of the product. The visual searching query may include a ratio among colors of the product. The visual searching query may include colors of the product having the same ratio. The visual searching query may include colors of the product having different ratios from one another. The ratio of the colors may be continuously adjusted by dragging of an input device (e.g. a mouse) of a user. For example, the visual searching query may include a first color of 50%, a second color of 30% and a third color of 20%. Accordingly, the product searching part 300 may outputs the product images having the first color of about 50%, the second color of about 30% and the third color of about 20% as the searching results.

For example, the visual searching query includes a pattern of the product. The pattern may include a horizontal stripe pattern, a vertical stripe pattern, a diagonal pattern, a dot pattern and so on.

FIG. 3 is a block diagram illustrating the product area determining part 100 of FIG. 1. FIG. 4 is a conceptual diagram illustrating an operation of the product area determining part 100 of FIG. 1.

Referring to FIGS. 1 to 4, the product area determining part 100 includes a contour detecting part 110 and a product area extracting part 120.

The contour detecting part 110 detects a contour of an object in the input image. The contour detecting part 110 outputs the contour information of the input image to the product area extracting part 120.

The product area extracting part 120 receives the contour information of the input image and the product category. The product area extracting part 120 determines whether the product area is detected or not based on the contour information and the product category.

When the contour information of the input image corresponds to the product category, the product area extracting part 120 succeeds to detect the product area. When the product area is detected, the product area extracting part 120 extracts the image in the product area to generate the output image.

When the contour information of the input image does not correspond to the product category, the product area extracting part 120 fails to detect the product area. When the product area is not detected, the product area extracting part 120 generates the output image using the input image. Alternatively, when the product area is not detected, the input image may not be used to search the product but omitted. When the product area is not detected, the product area extracting part 120 does not output the output image.

The product area extracting part 120 may operate training for determining a boundary between a success and a failure to detect the product area using a plurality of sample images for respective product categories. The product area extracting part 120 receives many sample images for respective product categories and true or false information corresponding to the sample images. The product area extracting part 120 trains an optimal boundary between the success and the failure to detect the product area based on the sample images for respective product categories and the true or false information corresponding to the sample images. As the number of the sample images increases, an accuracy of the detecting the product area of the product area extracting part 120 may increase.

The product area extracting part 120 may determine whether the product area is detected or not using a histogram method. For example, the product area extracting part 120 may generate a virtual box having a rectangular shape which is defined by horizontal outermost points of the contour of the object and vertical outermost points of the contour of the object. The product area extracting part 120 determines a central point of the virtual box.

The product area extracting part 120 determines a distance from the central point of the virtual box to the contour of the object in various directions and stores the distance in the various directions as a histogram.

In FIG. 4, for example, the product area extracting part 120 determines a distance from the central point of the virtual box to the contour of the object in eight directions. The product area extracting part 120 may store a distanced d1 from the central point of the virtual box to the contour of the object in a first direction, a distance d2 from the central point of the virtual box to the contour of the object in a second direction, a distance d3 from the central point of the virtual box to the contour of the object in a third direction, a distance d4 from the central point of the virtual box to the contour of the object in a fourth direction, a distance d5 from the central point of the virtual box to the contour of the object in a fifth direction, a distance d6 from the central point of the virtual box to the contour of the object in a sixth direction, a distance d7 from the central point of the virtual box to the contour of the object in a seventh direction and a distance d8 from the central point of the virtual box to the contour of the object in an eighth direction. The first to eighth directions may be rotated in a specific angle from one another. An angle a between the first direction and the second direction may be 45 degrees.

The product area extracting part 120 determines histograms for the sample images and sets the optimal boundary between the success and the failure to detect the product area based on the histogram. The product area extracting part 120 determines the histogram of the contour information of the input image and compares the histogram of the contour information of the input image to the optimal boundary for the product category so that the product area extracting part 120 may determine whether the product area of the input image is detected or not.

FIG. 5 is a flowchart diagram illustrating an operation of a visual word generating part 200 of FIG. 1.

Referring to FIGS. 1 to 5, the visual word generating part 200 operates a numerical clustering to the visual information extracted from images (step S600).

The numerical clustering means a clustering using numerical values. When the visual word is a color, the colors may be numerically clustered using a distance in a first color space.

For example, when the first color space includes a plurality of axes, the colors may be numerically clustered using a distance of color coordinates defined by the axes.

For example, when the first color space is CIELAB color space and L axis, a axis and b axis respectively correspond to X axis, Y axis and Z axis, the colors may be numerically clustered using a distance of color coordinates defined by the X coordinate, Y coordinate and Z coordinate.

For example, when the first color space is RGB color space and a red axis, a green axis and a blue axis respectively correspond to X axis, Y axis and Z axis, the colors may be numerically clustered using a distance of color coordinates defined by the X coordinate, Y coordinate and Z coordinate.

Alternatively, the numerical clustering is operated using one of CIEXYZ color space, CMYK color space, HSV color space, YPbPr color space and YCbCr color space.

The visual word generating part 200 operates a cognitive clustering to the numerical clusters reflecting the human visual cognition characteristics (step S700).

The cognitive clustering reflects the human visual cognition characteristics. When the visual word is a color, although a distance between a first color coordinate and a second color coordinate is same as a distance between the second color coordinate and a third color coordinate, a cognitive difference between the first color coordinate and the second color coordinate may be different from cognitive difference between the second color coordinate and the third color coordinate. Accordingly, the numerical clusters may be cognitively clustered using the human visual cognition characteristics. The human visual cognition characteristics may include a luminance difference for various colors and an optical illusion.

The cognitive clustering may use a second color space. The first color space may be nonlinearly converted to generate the second color space. The second color space has a dimension higher than a dimension of the first color space. For example, when the first color space is a three dimensional color space which is defined by three axes, the second color space, which is a result of nonlinear conversion of the first color space, may have a dimension greater than three. For example, the second color space may have nine dimensions. For example, the second color space may have twenty dimensions.

The visual word generating part 200 may collect human visual cognitive relations to the cognitive clustering. The human visual cognitive relations are defined by similarity between the numerical clusters by human cognition. For example, a first numerical cluster looks similar to a second numerical cluster by human eyes, the first numerical cluster and the second numerical cluster may be cognitively clustered. In contrast, the first numerical cluster does not look similar to a third numerical cluster by human eyes, the first numerical cluster and the third numerical cluster may not be cognitively clustered. The visual word generating part 200 collects and trains a plurality of human visual cognitive relations. The visual word generating part 200 operates the cognitive clustering based on the result of the training of the human visual cognitive relations.

For example, when the first color space for the numerical clustering is CIELAB color space, weights for X, Y and Z axes corresponding to L, a and b axes may be set different from one another.

For example, when the first color space for the numerical clustering is RGB color space, weights for X, Y and Z axes corresponding to the red axis, the green axis and the blue axis may be set different from one another

The visual word generating part 200 may generate the visual word of the output image outputted from the product area determining part 100 based on results of the numerical clustering and the cognitive clustering.

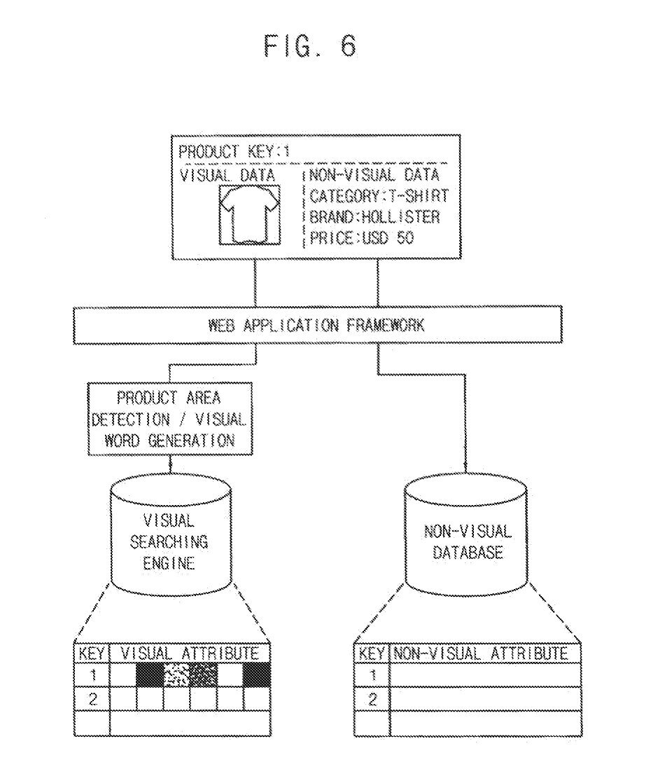

FIG. 6 is a conceptual diagram illustrating a structure and an operation of the visual product searching apparatus of FIG. 1.

Referring to FIGS. 1 to 6, the visual product searching apparatus includes the product area determining part 100, the visual word generating part 200 and the product searching part 300. The product searching past 300 may include a visual database and a non-visual database.

In FIG. 6, a product having a product key of 1 has visual information of input image including a shape of t-shirt having a bright color on a dark background. The product having the product key of 1 also includes non-visual information such as a category (T-shirt), a brand (Hollister) and a price (USD 50).

The visual information of input image may be linked with the non-visual information such as the category, the brand and the price by the product key (1).

The product area determining part 100 determines the image in the product area in the input image which is one of the visual information. In the present exemplary embodiment, the shape of the t-shirt having the bright color may be extracted but the dark background may be omitted in the input image of the product having the product key of 1.

The visual word generating part 200 generates the visual word reflecting the human visual cognitive characteristics based on the extracted product area.

The visual word is stored in the visual database with the product key.

The non-visual information is stored in the non-visual database with the product key.

The product searching part 300 receives the searching query and outputs the searching result corresponding to the searching query. The product searching part 300 may output the searching result using the visual database and the non-visual database.

According to the present exemplary embodiment, the visual product searching apparatus does not rely on tagging but automatically extracts and classifies the visual information so that the visual information of the products may be effectively searched.

In addition, the product area is extracted in the product image so that the visual information may be accurately searched.

In addition, when the visual word is determined from the extracted product area, a cognitive clustering is performed based on the human visual characteristics so that a satisfaction of the searching result of the visual information may be improved.

The foregoing is illustrative of the present inventive concept and is not to be construed as limiting thereof. Although a few exemplary embodiments of the present inventive concept have been described, those skilled in the art will readily appreciate that many modifications are possible in the exemplary embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific exemplary embodiments disclosed, and that modifications to the disclosed exemplary embodiments, as well as other exemplary embodiments, are intended to be included within the scope of the appended claims. The present inventive concept is defined by the following claims, with equivalents of the claims to be included therein.

What is claimed is:

1. A visual product searching apparatus comprising:
a product area determining part configured to extract a product area in an input image;
a visual word generating part configured to generate a visual word reflecting human visual cognitive characteristics based on the product area; and
a product searching part configured to search a product using the visual word.

2. The visual product searching apparatus of claim 1, wherein the product area determining part comprises:
a contour detecting part configured to detect a contour of an object in the input image; and
a product area extracting part configured to determine whether the product area is detected or not based on the contour of the object and a product category.

3. The visual product searching apparatus of claim 2, wherein when the product area is detected, the product area extracting part extracts an image in the product area to generate an output image; and
when the product area is not detected, the product area extracting part generates the output image using the input image.

4. The visual product searching apparatus of claim 2, wherein the product area extracting part is configured to operate training for determining a boundary between a success and a failure to detect the product area using a plurality of sample images for respective product categories.

5. The visual product searching apparatus of claim 2, wherein the product area extracting part is configured to generate a virtual box having a rectangular shape which is defined by horizontal outermost points of the contour of live object and vertical outermost points of the contour of the object and to determine whether the product area of the input image is detected or not using a histogram including distances from a central point of the virtual box to the contour of the object in various directions.

6. The visual product searching apparatus of claim 1, wherein the visual word generating part is configured to operate numerical clustering to visual information and to operate cognitive clustering to the numerical clusters reflecting human visual cognition characteristics, and
the visual word generating part is configured to generate the visual word of the output image outputted from the product area determining part based on the cognitive clusters.

7. The visual product searching apparatus of claim 6, wherein the visual word represents a color,
the colors are numerically clustered using a distance of color coordinates defined by a plurality of axes,
the cognitive clustering uses a second color space and the first color space is nonlinearly converted to generate the second color space, and
the second color space has a dimension higher than a dimension of the first color space.

8. The visual product searching apparatus of claim 1, wherein the product searching part is configured to receive a searching query and to output a searching result corresponding to the searching query, and
the searching query includes a plurality of colors of the product having different ratios from one another.

9. The visual product searching apparatus of claim 1, wherein the product searching part comprises a visual database configured to store the visual word of the product and a non-visual database configured to store non-visual information of the product, and
the visual database and the non-visual database are linked with each other by a product key.

10. A method of visually searching a product, the method comprising:
extracting a product area in an input image;
generating a visual word reflecting human visual cognitive characteristics based on the product area; and
searching the product using the visual word.

11. The method of claim 10, wherein the extracting the product area comprises:
detecting a contour of an object in the input image; and
determining whether the product area is detected or not based on the contour of the object and a product category.

12. The method of claim 11, wherein the determining whether the product area is detected or not comprises:
when the product area is detected, extracting an image in the product area to generate an output image, and
when the product area is not detected, generating the output image using the input image.

13. The method of claim 10, wherein the generating the visual word reflecting human visual cognitive characteristics comprises:
operating numerical clustering to visual information;
operating cognitive clustering to the numerical clusters reflecting human visual cognition characteristics; and
generating the visual word of the output image outputted from the product area determining part based on the cognitive clusters.
